(19) United States
(12) Patent Application Publication
(10) Pub. No.: US 2026/0269118 A1
(43) Pub. Date: Sep. 10, 2026

(54) MULTILAYER COIL COMPONENT

(71) Applicant: TDK Corporation, Tokyo (JP)

(72) Inventors: Yusuke NAGAI, Tokyo (JP); Kazuhiro EBINA, Tokyo (JP); Takahiro SATO, Tokyo (JP); Makoto YOSHINO, Tokyo (JP); Takuya MIYASHITA, Tokyo (JP); Shin TSUKAMOTO, Tokyo (JP); Takumi ITO, Tokyo (JP); Shota KAIGUCHI, Tokyo (JP)

(73) Assignee: TDK Corporation, Tokyo (JP)

(21) Appl. No.: 19/555,335

(22) Filed: Mar. 3, 2026

(30) Foreign Application Priority Data
Mar. 5, 2025 (JP) 2025-034329

(51) Int. Cl. H01F 27/28; H01F 27/32

(52) U.S. Cl. CPC H01F 27/2804; H01F 27/323; H01F 2027/2809

(57) ABSTRACT

A multilayer coil component includes an element body, and a first coil and a second coil disposed inside the element body and provided coaxially. The first coil includes a first coil conductor, a second coil conductor, and a third coil conductor. The element body includes a first insulating layer interposed between the first coil conductor and the second coil conductor, and a second insulating layer interposed between the second coil conductor and the third coil conductor. The first coil conductor, the second coil conductor, the third coil conductor, and the second coil are disposed in this order along an axial direction of the first coil. A thickness of the second insulating layer is greater than a thickness of the first insulating layer.

### TECHNICAL FIELD

The present disclosure relates to a multilayer coil component. This application claims priority based on Japanese Patent Application No. 2025-034329 filed on Mar. 5, 2025, the entire contents of which are incorporated herein by reference.

### BACKGROUND

International Publication No. 2007/043309 describes a multilayer coil component including a first coil part incorporating a first spiral coil, a second coil part incorporating a second spiral coil, and a laminate configured by stacking the first coil part and the second coil part. In this multilayer coil component, the first spiral coil and the second spiral coil have coil axes positioned coaxially with each other and are electrically connected in parallel.

### SUMMARY

The present disclosure aims to improve DC superposition characteristics.

(1) A multilayer coil component according to a first aspect of the present disclosure includes an element body, and a first coil and a second coil disposed inside the element body and provided coaxially, wherein the first coil includes a first coil conductor, a second coil conductor, and a third coil conductor, wherein the element body includes a first insulating layer interposed between the first coil conductor and the second coil conductor, and a second insulating layer interposed between the second coil conductor and the third coil conductor, wherein the first coil conductor, the second coil conductor, the third coil conductor, and the second coil are disposed in this order along an axial direction of the first coil, and wherein a thickness of the second insulating layer is greater than a thickness of the first insulating layer.

In the multilayer coil component described above, of the first insulating layer and the second insulating layer interposed between the coil conductors of the first coil, the thickness of the second insulating layer closer to the second coil is greater than the thickness of the first insulating layer, so that a distribution of magnetic flux of the first coil becomes uniform, and DC superposition characteristics of the first coil can be improved. As a result, the DC superposition characteristics of the multilayer coil component can be improved.

(2) In the multilayer coil component described in (1) above, the first coil may include a plurality of coil conductors laminated along the axial direction, the element body may include a plurality of insulating layers respectively interposed between adjacent coil conductors of the plurality of coil conductors, and thicknesses of the plurality of insulating layers may become greater toward the second coil. In this case, the distribution of magnetic flux of the first coil becomes more uniform, and the DC superposition characteristics of the first coil can be further improved. As a result, the DC superposition characteristics of the multilayer coil component can be further improved.

(3) In the multilayer coil component described in (1) or (2) above, the first insulating layer and the second insulating layer may include metal particles, and a density of the metal particles in the second insulating layer may be lower than a density of the metal particles in the first insulating layer. In this case, the distribution of magnetic flux of the first coil becomes more uniform, and the DC superposition characteristics of the first coil can be further improved. As a result, the DC superposition characteristics of the multilayer coil component can be further improved.

(4) In the multilayer coil component described in any one of (1) to (3) above, the first insulating layer and the second insulating layer may include metal particles, and an average particle diameter of the metal particles in the second insulating layer may be smaller than an average particle diameter of the metal particles in the first insulating layer. In this case, the distribution of magnetic flux of the first coil becomes more uniform, and the DC superposition characteristics of the first coil can be further improved. As a result, the DC superposition characteristics of the multilayer coil component can be further improved.

(5) In the multilayer coil component described in any one of (1) to (4) above, the second coil may include a fourth coil conductor, a fifth coil conductor, and a sixth coil conductor, wherein the element body may include a third insulating layer interposed between the fourth coil conductor and the fifth coil conductor, and a fourth insulating layer interposed between the fifth coil conductor and the sixth coil conductor, wherein the first coil conductor, the second coil conductor, the third coil conductor, the fourth coil conductor, the fifth coil conductor, and the sixth coil conductor may be disposed in this order along the axial direction, and wherein a thickness of the third insulating layer may be greater than a thickness of the fourth insulating layer. In this case, of the third insulating layer and the fourth insulating layer interposed between the coil conductors of the second coil, the thickness of the third insulating layer closer to the first coil is greater than the thickness of the fourth insulating layer, so that a distribution of magnetic flux of the second coil becomes uniform, and DC superposition characteristics of the second coil can be improved. As a result, the DC superposition characteristics of the multilayer coil component can be further improved.

(6) In the multilayer coil component described in any one of (1) to (5) above, the third insulating layer and the fourth insulating layer may include metal particles, and a density of the metal particles in the third insulating layer may be lower than a density of the metal particles in the fourth insulating layer. In this case, the distribution of magnetic flux of the second coil becomes more uniform, and the DC superposition characteristics of the second coil can be further improved. As a result, the DC superposition characteristics of the multilayer coil component can be even further improved.

(7) In the multilayer coil component described in any one of (1) to (6) above, the third insulating layer and the fourth insulating layer may include metal particles, and an average particle diameter of the metal particles in the third insulating layer may be smaller than an average particle diameter of the metal particles in the fourth insulating layer. In this case, the distribution of magnetic flux of the second coil becomes more uniform, and the DC superposition characteristics of the second coil can be further improved. As a result, the DC superposition characteristics of the multilayer coil component can be even further improved.

(8) In the multilayer coil component described in any one of (1) to (7) above, the element body may include a first main surface facing the first coil in the axial direction and constituting a mounting surface, and a second main surface facing the second coil in the axial direction. In this case, a conductor portion connecting the second coil far from the mounting surface and an external electrode tends to be longer than a conductor portion connecting the first coil close to the mounting surface and an external electrode. As a result, the DC superposition characteristics of the second coil tend to be smaller than the DC superposition characteristics of the first coil. Therefore, for aligning the DC superposition characteristics of the first coil and the DC superposition characteristics of the second coil, a configuration improving the DC superposition characteristics of the first coil is effective.

(9) In the multilayer coil component described in any one of (1) to (8) above, the first insulating layer and the second insulating layer may be provided outside and inside the first coil when viewed from the axial direction. In this case, since the first insulating layer and the second insulating layer can be provided on the entire surface of the element body, manufacturing is easy.

(10) A multilayer coil component according to a second aspect of the present disclosure includes an element body, and a first coil and a second coil disposed inside the element body and provided coaxially, wherein the first coil includes a first coil conductor, a second coil conductor, and a third coil conductor, wherein the element body includes a first insulating layer interposed between the first coil conductor and the second coil conductor, and a second insulating layer interposed between the second coil conductor and the third coil conductor, wherein the first coil conductor, the second coil conductor, the third coil conductor, and the second coil are disposed in this order along an axial direction of the first coil, wherein the first insulating layer and the second insulating layer include metal particles, and wherein a density of the metal particles in the second insulating layer is lower than a density of the metal particles in the first insulating layer.

In the multilayer coil component described above, of the first insulating layer and the second insulating layer interposed between the coil conductors of the first coil, the density of the metal particles in the second insulating layer closer to the second coil is lower than the density of the metal particles in the first insulating layer, so that a distribution of magnetic flux of the first coil becomes uniform, and DC superposition characteristics of the first coil can be improved. As a result, the DC superposition characteristics of the multilayer coil component can be improved.

(11) A multilayer coil component according to a third aspect of the present disclosure includes an element body, and a first coil and a second coil disposed inside the element body and provided coaxially, wherein the first coil includes a first coil conductor, a second coil conductor, and a third coil conductor, wherein the element body includes a first insulating layer interposed between the first coil conductor and the second coil conductor, and a second insulating layer interposed between the second coil conductor and the third coil conductor, wherein the first coil conductor, the second coil conductor, the third coil conductor, and the second coil are disposed in this order along an axial direction of the first coil, wherein the first insulating layer and the second insulating layer include metal particles, and wherein an average particle diameter of the metal particles in the second insulating layer is smaller than an average particle diameter of the metal particles in the first insulating layer.

In the multilayer coil component described above, of the first insulating layer and the second insulating layer interposed between the coil conductors of the first coil, the average particle diameter of the metal particles in the second insulating layer closer to the second coil is smaller than the average particle diameter of the metal particles in the first insulating layer, so that a distribution of magnetic flux of the first coil becomes uniform, and DC superposition characteristics of the first coil can be improved. As a result, the DC superposition characteristics of the multilayer coil component can be improved.

(12) In the multilayer coil component described in (10) or (11) above, a thickness of the second insulating layer may be greater than a thickness of the first insulating layer. In this case, the DC superposition characteristics of the multilayer coil component can be further improved.

### BRIEF DESCRIPTION OF THE DRAWINGS

FIG. 1 is a perspective view of a multilayer coil component according to a first embodiment.

FIG. 2 is a cross-sectional view of the multilayer coil component of FIG. 1.

FIG. 3 is an exploded perspective view showing a layer configuration of the multilayer coil component of FIG. 1.

FIG. 4 is an enlarged cross-sectional view showing a part of an insulating layer.

FIG. 5A and FIG. 5B are diagrams showing simulation results of magnetic flux density distribution.

FIG. 6 is a perspective view of a multilayer coil component according to a second embodiment.

FIG. 7 is an exploded perspective view showing a layer configuration of the multilayer coil component of FIG. 6.

FIG. 8 is a perspective view of a multilayer coil component according to a third embodiment.

FIG. 9 is an exploded perspective view showing a layer configuration of the multilayer coil component of FIG. 8.

### DETAILED DESCRIPTION

Hereinafter, embodiments of the present disclosure will be described in detail with reference to the accompanying drawings. In the description of the drawings, the same or corresponding elements are denoted by the same reference numerals, and redundant description will be omitted.

### First Embodiment

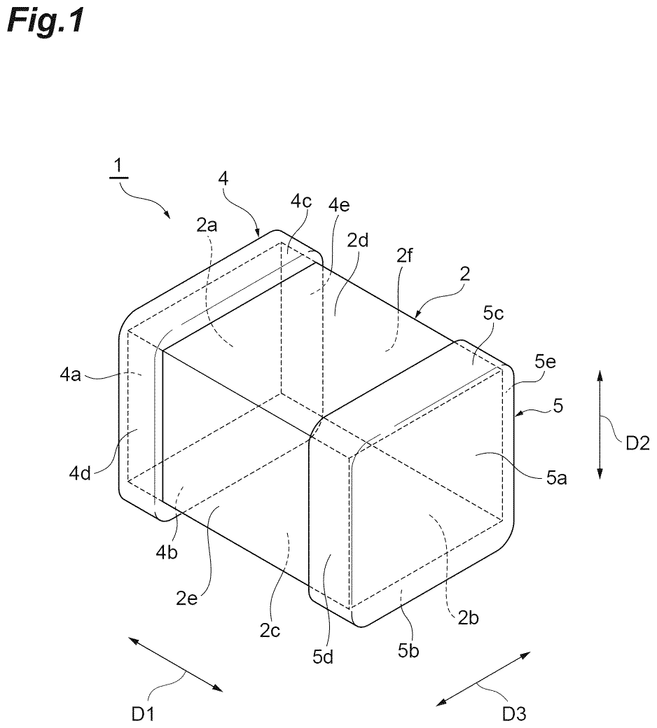

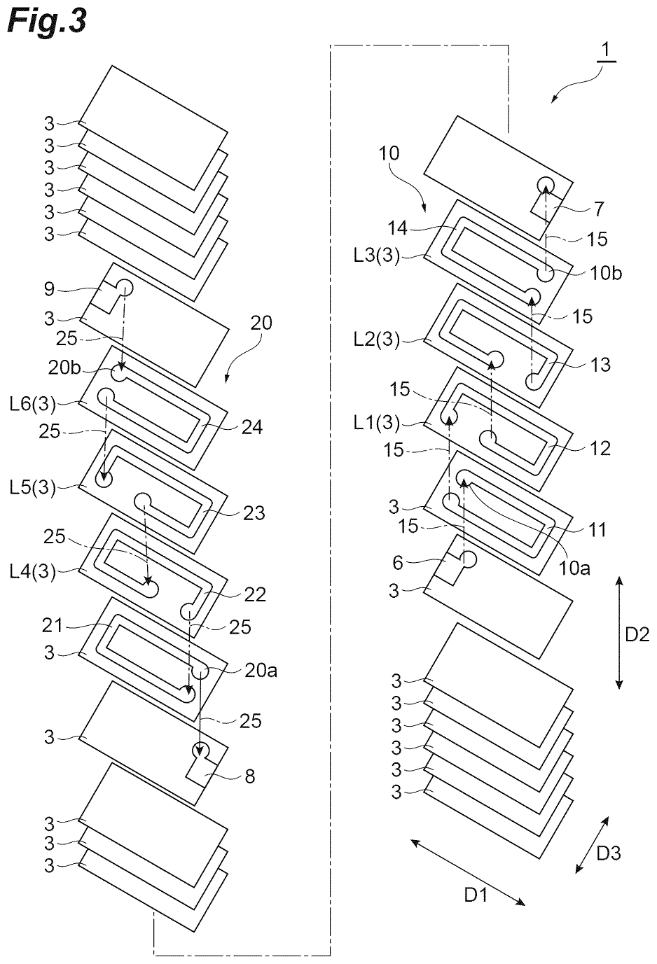

A multilayer coil component 1 according to a first embodiment will be described with reference to FIGS. 1 to 4. As shown in FIGS. 1 to 3, the multilayer coil component 1 includes an element body 2, an external electrode 4, an external electrode 5, a connecting conductor 6, a connecting conductor 7, a connecting conductor 8, a connecting conductor 9, a coil 10, and a coil 20. The connecting conductors 6, 7, 8, 9 (hereinafter, connecting conductors 6 to 9) and the coils 10, 20 are internal conductors and are disposed inside the element body 2. In FIG. 3, illustration of the external electrodes 4, 5 is omitted. The multilayer coil component 1 is applicable to, for example, a bead inductor or a power inductor.

The element body 2 has a rectangular parallelepiped shape. The rectangular parallelepiped shape includes a shape of a rectangular parallelepiped in which corner portions and ridge line portions are chamfered, and a shape of a rectangular parallelepiped in which corner portions and ridge line portions are rounded. The element body 2 has end surfaces 2a, 2b facing each other, main surfaces 2c, 2d facing each other, and side surfaces 2e, 2f facing each other as outer surfaces of the element body 2.

Hereinafter, a facing direction of the end surfaces 2a, 2b is defined as a first direction D1, a facing direction of the main surfaces 2c, 2d is defined as a second direction D2, and a facing direction of the side surfaces 2e, 2f is defined as a third direction D3. The first direction D1, the second direction D2, and the third direction D3 intersect each other (are orthogonal in the present embodiment). The first direction D1 is a length direction of the element body 2. The second direction D2 is a height direction of the element body 2. The third direction D3 is a width direction of the element body 2.

The end surfaces 2a, 2b extend in the second direction D2 so as to connect the main surfaces 2c, 2d. The end surfaces 2a, 2b extend in the third direction D3 so as to connect the side surfaces 2e, 2f. The main surfaces 2c, 2d extend in the first direction D1 so as to connect the end surfaces 2a, 2b. The main surfaces 2c, 2d extend in the third direction D3 so as to connect the side surfaces 2e, 2f. The side surfaces 2e, 2f extend in the first direction D1 so as to connect the end surfaces 2a, 2b. The side surfaces 2e, 2f extend in the second direction D2 so as to connect the main surfaces 2c, 2d.

A height (length in the second direction D2) and a width (length in the third direction D3) of the element body 2 are shorter than a length (length in the first direction D1) of the element body 2. The height and the width of the element body 2 are, for example, equivalent to each other. In the description of the embodiments, “equivalent” does not necessarily mean only that the values are identical. Even if a minute difference in a preset range, a manufacturing error, or a measurement error is included in the values, the values may be considered equivalent.

The height of the element body 2 is, for example, 0.05 mm or more and 2.50 mm or less, and is 1.00 mm as an example. The width of the element body 2 is, for example, 0.05 mm or more and 2.50 mm or less, and is 2.00 mm as an example. The length of the element body 2 is, for example, 0.10 mm or more and 3.50 mm or less, and is 2.50 mm as an example. The height and the width of the element body 2 may be equal to or greater than the length of the element body 2. The height of the element body 2 may be longer than the width of the element body 2, or may be shorter.

The main surface 2c is, for example, a surface (mounting surface) facing an electronic device when the multilayer coil component 1 is mounted on the electronic device (not shown). The electronic device includes, for example, a circuit board or an electronic component. The end surfaces 2a, 2b and the side surfaces 2e, 2f are surfaces adjacent to the main surface 2c, respectively. The first direction D1 and the third direction D3 are directions along the main surface 2c, respectively. The second direction D2 is a direction intersecting (orthogonal in the present embodiment) the main surface 2c.

The element body 2 includes a plurality of insulating layers 3 laminated in the second direction D2. A lamination direction of the plurality of insulating layers 3 is the second direction D2. The element body 2 is configured by laminating the plurality of insulating layers 3 in the second direction D2. In the actual element body 2, the plurality of insulating layers 3 are integrated to such an extent that boundaries between the layers cannot be visually recognized.

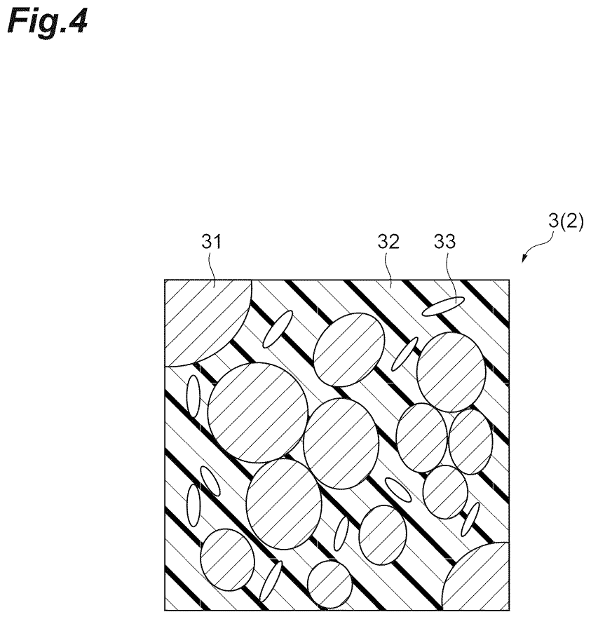

As shown in FIG. 4, the insulating layer 3 includes a plurality of metal particles 31. The insulating layer 3 is, for example, a magnetic layer. The metal particles 31 are, for example, metal magnetic particles. The metal particles 31 are composed of, for example, a soft magnetic alloy. The soft magnetic alloy is, for example, an Fe—Si based alloy. When the soft magnetic alloy is an Fe—Si based alloy, the soft magnetic alloy may include P. The soft magnetic alloy may be, for example, an Fe—Ni—Si—M based alloy. “M” includes one or more elements selected from Co, Cr, Mn, P, Ti, Zr, Hf, Nb, Ta, Mo, Mg, Ca, Sr, Ba, Zn, B, Al, and rare earth elements.

The insulating layer 3 includes a resin 32. The resin 32 exists between the plurality of metal particles 31. The resin 32 is a resin having electrical insulation properties. The resin 32 is an insulating resin. The insulating resin includes, for example, a silicone resin, a phenol resin, an acrylic resin, or an epoxy resin. In the insulating layer 3, there are voids 33 between the plurality of metal particles 31 where the resin 32 does not exist.

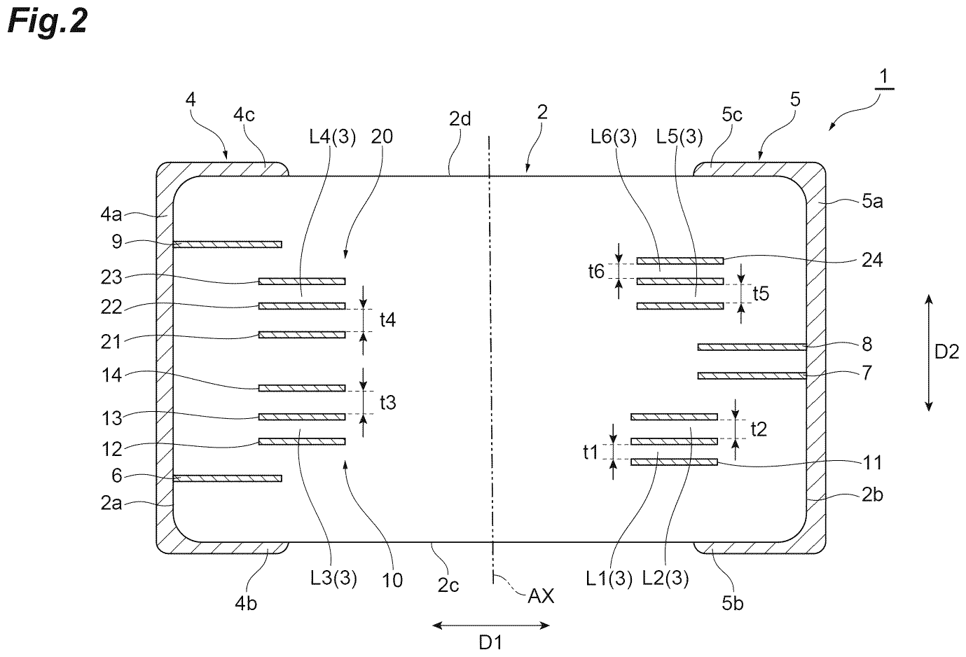

As shown in FIGS. 1 and 2, the external electrodes 4, 5 are disposed at both end portions of the element body 2 in the first direction D1. The external electrodes 4, 5 are separated from each other in the first direction D1. The external electrode 4 is disposed at an end portion including the end surface 2a of the element body 2. The external electrode 5 is disposed at an end portion including the end surface 2b of the element body 2. The external electrodes 4, 5 include a conductive material. The conductive material is, for example, Ag or Pd. The external electrodes 4, 5 are configured as sintered bodies of conductive paste. The conductive paste includes conductive metal powder and glass frit. The conductive metal powder is, for example, Ag powder or Pd powder. Plating layers are formed on surfaces of the external electrodes 4, 5. The plating layers are formed by, for example, electroplating. The electroplating is, for example, Ni electroplating or Sn electroplating.

The external electrode 4 is disposed on the end surface 2a, the main surface 2c, the main surface 2d, the side surface 2e, and the side surface 2f. The external electrode 4 includes five electrode portions. The external electrode 4 includes an electrode portion 4a positioned on the end surface 2a, an electrode portion 4b positioned on the main surface 2c, an electrode portion 4c positioned on the main surface 2d, an electrode portion 4d positioned on the side surface 2e, and an electrode portion 4e positioned on the side surface 2f. The electrode portion 4a covers the entire surface of the end surface 2a. The electrode portion 4b covers a part of the main surface 2c. The electrode portion 4c covers a part of the main surface 2d. The electrode portion 4d covers a part of the side surface 2e. The electrode portion 4e covers a part of the side surface 2f. The five electrode portions 4a, 4b, 4c, 4d, 4e are integrally formed.

The external electrode 5 is disposed on the end surface 2b, the main surface 2c, the main surface 2d, the side surface 2e, and the side surface 2f. The external electrode 5 includes five electrode portions. The external electrode 5 includes an electrode portion 5a positioned on the end surface 2b, an electrode portion 5b positioned on the main surface 2c, an electrode portion 5c positioned on the main surface 2d, an electrode portion 5d positioned on the side surface 2e, and an electrode portion 5e positioned on the side surface 2f. The electrode portion 5a covers the entire surface of the end surface 2b. The electrode portion 5b covers a part of the main surface 2c. The electrode portion 5c covers a part of the main surface 2d. The electrode portion 5d covers a part of the side surface 2e. The electrode portion 5e covers a part of the side surface 2f. The five electrode portions 5a, 5b, 5c, 5d, 5e are integrally formed.

The connecting conductor 6 is exposed at the end surface 2a and is connected to the electrode portion 4a of the external electrode 4. The connecting conductor 6 connects the coil 10 and the external electrode 4. The connecting conductor 7 is exposed at the end surface 2b and is connected to the electrode portion 5a of the external electrode 5. The connecting conductor 7 connects the coil 10 and the external electrode 5. The connecting conductor 8 is exposed at the end surface 2b and is connected to the electrode portion 5a of the external electrode 5. The connecting conductor 8 connects the coil 20 and the external electrode 5. The connecting conductor 9 is exposed at the end surface 2a and is connected to the electrode portion 4a of the external electrode 4. The connecting conductor 9 connects the coil 20 and the external electrode 4.

The connecting conductors 6, 9 have the same shape as each other and are disposed so as to overlap each other when viewed from the second direction D2. The connecting conductors 7, 8 have the same shape as each other and are disposed so as to overlap each other when viewed from the second direction D2. A plurality of insulating layers 3 are interposed between the connecting conductors 7, 8, and the connecting conductors 7, 8 are separated from each other in the second direction D2.

The coils 10, 20 are separated from the outer surfaces of the element body 2 and are disposed inside the element body 2. The coils 10, 20 are provided coaxially. The coils 10, 20 have a common coil axis AX along the second direction D2. An axial direction of the coils 10, 20 coincides with the second direction D2. The coil axis AX is orthogonal to the main surfaces 2c, 2d. The coil axis AX extends along the end surfaces 2a, 2b and the side surfaces 2e, 2f. The coil axis AX coincides with a central axis of the element body 2 and is disposed so as to pass through a center of gravity of the element body 2.

The coils 10, 20 are arranged in the second direction D2. The coils 10, 20 are separated from each other in the second direction D2. A plurality of insulating layers 3 are interposed between the coils 10, 20. A total thickness of the plurality of insulating layers 3 interposed between the coils 10, 20, that is, a length in the second direction D2 between the coils 10, 20 is, for example, ½ or less of the height (length in the second direction D2) of the element body 2, may be ⅓ or less, or may be ¼ or less.

The coil 10 faces the main surface 2c in the second direction D2. The coil 20 faces the main surface 2d in the second direction D2. The coil 10 is disposed closer to the main surface 2c than the coil 20. The coil 20 is disposed closer to the main surface 2d than the coil 10. The coil 10 is spaced apart from the main surface 2c. The coil 20 is spaced apart from the main surface 2d. The main surface 2c is constituted by a surface of a cover layer covering the coil 10. The main surface 2d is constituted by a surface of a cover layer covering the coil 20. Each of these cover layers is a laminate of a plurality of insulating layers 3, but may be a single insulating layer 3.

When viewed from the second direction D2, the coils 10, 20 overlap each other. When viewed from the second direction D2, the coils 10, 20 coincide with each other. When viewed from the second direction D2, each of the coils 10, 20 has a rectangular annular shape with the first direction D1 as a longitudinal direction. When viewed from the second direction D2, each of the coils 10, 20 is spaced apart from the end surfaces 2a, 2b by an equal distance. When viewed from the second direction D2, each of the coils 10, 20 is spaced apart from the side surfaces 2e, 2f by an equal distance.

The coil 10 includes a first end 10a connected to the connecting conductor 6, and a second end 10b connected to the connecting conductor 7. The coil 10 includes a plurality of coil conductors 11, 12, 13, 14 (hereinafter, coil conductors 11 to 14). The coil 10 is configured by the coil conductors 11 to 14 being connected by a plurality of through hole conductors 15. Each through hole conductor 15 connects a pair of adjacent coil conductors among the coil conductors 11 to 14. The through hole conductors 15 are also internal conductors. In FIG. 3, an example of a direction in which current flows in the through hole conductors 15 is indicated by arrows.

The coil conductors 11 to 14 are laminated along the axial direction (second direction D2). Among the plurality of coil conductors 11 to 14, the coil conductor 11 is disposed closest to the main surface 2c, and the coil conductor 14 is disposed closest to the coil 20. The coil conductor 11 includes the first end 10a of the coil 10. The first end 10a is connected to the connecting conductor 6 by the through hole conductor 15. The coil conductor 14 includes the second end 10b of the coil 10. The second end 10b is connected to the connecting conductor 7 by the through hole conductor 15.

The coil 20 includes a first end 20a connected to the connecting conductor 8, and a second end 20b connected to the connecting conductor 9. The coil 20 includes a plurality of coil conductors 21, 22, 23, 24 (hereinafter, coil conductors 21 to 24). The coil 20 is configured by the coil conductors 21 to 24 being connected by a plurality of through hole conductors 25. Each through hole conductor 25 connects a pair of adjacent coil conductors among the coil conductors 21 to 24. In FIG. 3, an example of a direction in which current flows in the through hole conductors 25 is indicated by arrows.

The coil conductors 21 to 24 are laminated along the axial direction (second direction D2). Among the plurality of coil conductors 21 to 24, the coil conductor 21 is disposed closest to the coil 10, and the coil conductor 24 is disposed closest to the main surface 2d. The coil conductor 21 includes the first end 20a of the coil 20. The first end 20a is connected to the connecting conductor 8 by the through hole conductor 25. The coil conductor 24 includes the second end 20b of the coil 20. The second end 20b is connected to the connecting conductor 9 by the through hole conductor 25.

The coil conductors 11 to 14 and the coil conductors 21 to 24 are arranged from the main surface 2c toward the main surface 2d in the order of the coil conductor 11, the coil conductor 12, the coil conductor 13, the coil conductor 14, the coil conductor 21, the coil conductor 22, the coil conductor 23, and the coil conductor 24 along the axial direction (second direction D2). The coil conductors 11 to 14 and the coil conductors 21 to 24 are formed on the corresponding insulating layers 3, respectively.

The coils 10, 20 have the same shape as each other and have the same number of turns. The coils 10, 20 are disposed so as to be plane-symmetrical to each other with respect to a plane orthogonal to the second direction D2 and positioned at the center of the element body 2 in the second direction D2. The coil conductors 11, 24 have the same shape as each other. The coil conductors 12, 23 have the same shape as each other. The coil conductors 13, 22 have the same shape as each other. The coil conductors 14, 21 have the same shape as each other. The coils 10, 20 may have different shapes or may have different numbers of turns.

The coil conductors 11 to 14, the coil conductors 21 to 24, the connecting conductors 6 to 9, and the through hole conductors 15, 25 include a conductive material such as Ag or Pd. The coil conductors 11 to 14, the coil conductors 21 to 24, the connecting conductors 6 to 9, and the through hole conductors 15, 25 are configured as sintered bodies of conductive paste including conductive material (for example, Ag powder or Pd powder).

The plurality of insulating layers 3 include insulating layers L1, L2, L3 interposed between adjacent coil conductors in the axial direction (second direction D2) of the coil 10, and insulating layers L4, L5, L6 interposed between adjacent coil conductors in the axial direction (second direction D2) of the coil 20.

The insulating layer L1 is interposed between the coil conductor 11 and the coil conductor 12. The insulating layer L2 is interposed between the coil conductor 12 and the coil conductor 13. The insulating layer L3 is interposed between the coil conductor 13 and the coil conductor 14. The insulating layer L4 is interposed between the coil conductor 21 and the coil conductor 22. The insulating layer L5 is interposed between the coil conductor 22 and the coil conductor 23. The insulating layer L6 is interposed between the coil conductor 23 and the coil conductor 24.

The insulating layers L1 to L6 are provided not only between the coil conductors but also outside and inside the coils 10, 20 when viewed from the second direction D2. The insulating layers L1 to L6 have the same shape as the element body 2 when viewed from the second direction D2. The insulating layers L1 to L6 are provided over the entirety of the first direction D1 and the third direction D3 of the element body 2.

The thicknesses of the insulating layers L1 to L6 will be described. Here, a length in the second direction D2 of a portion interposed between adjacent coil conductors in the second direction D2 among the insulating layers L1 to L6 is defined as the thickness of the insulating layers L1 to L6. That is, the thickness of the insulating layers L1 to L6 is equal to a distance (shortest distance) between the coil conductors where the insulating layer is interposed. A thickness t1 of the insulating layer L1 is equal to a distance between the coil conductors 11, 12. A thickness t2 of the insulating layer L2 is equal to a distance between the coil conductors 12, 13. A thickness t3 of the insulating layer L3 is equal to a distance between the coil conductors 13, 14. A thickness t4 of the insulating layer L4 is equal to a distance between the coil conductors 21, 22. A thickness t5 of the insulating layer L5 is equal to a distance between the coil conductors 22, 23. A thickness t6 of the insulating layer L6 is equal to a distance between the coil conductors 23, 24.

The thickness t2 is greater than the thickness t1, and the thickness t3 is greater than the thickness t2 (t3>t2>t1). The thicknesses of the insulating layers L1, L2, L3 become greater toward the coil 20. The thickness t5 is greater than the thickness t6, and the thickness t4 is greater than the thickness t5 (t4>t5>t6). The thicknesses of the insulating layers L4, L5, L6 become greater toward the coil 10. The thicknesses t1, t6 are equivalent to each other. The thicknesses t2, t5 are equivalent to each other. The thicknesses t3, t4 are equivalent to each other.

The insulating layers L1, L2, L3 include metal particles 31. The insulating layers L1, L2, L3 include metal particles 31 of different densities, respectively. The metal particles 31 are substantially uniformly dispersed in each of the insulating layers L1, L2, L3. A density of the metal particles 31 in the insulating layer L2 is lower than a density of the metal particles 31 in the insulating layer L1, and a density of the metal particles 31 in the insulating layer L3 is lower than the density of the metal particles 31 in the insulating layer L2. In the insulating layers L1, L2, L3, the density of the metal particles 31 becomes lower stepwise for each layer toward the coil 20.

The insulating layers L4, L5, L6 include metal particles 31. The insulating layers L4, L5, L6 include metal particles 31 of different densities, respectively. The metal particles 31 are substantially uniformly dispersed in each of the insulating layers L4, L5, L6. A density of the metal particles 31 in the insulating layer L5 is lower than a density of the metal particles 31 in the insulating layer L6, and a density of the metal particles 31 in the insulating layer L4 is lower than the density of the metal particles 31 in the insulating layer L5. In the insulating layers L4, L5, L6, the density of the metal particles 31 becomes lower stepwise for each layer toward the coil 10.

The densities of the metal particles 31 in the insulating layers L1, L6 are equivalent to each other. The densities of the metal particles 31 in the insulating layers L2, L5 are equivalent to each other. The densities of the metal particles 31 in the insulating layers L3, L4 are equivalent to each other.

The “density” of each of the insulating layers L1 to L6 is obtained, for example, from at least one cross section of each of the insulating layers L1 to L6. In one example, “density” means an area of the metal particles 31 per unit area in an image of at least one cross section of each of the insulating layers L1 to L6.

An average particle diameter of the metal particles 31 in the insulating layer L2 is smaller than an average particle diameter of the metal particles 31 in the insulating layer L1. An average particle diameter of the metal particles 31 in the insulating layer L3 is smaller than the average particle diameter of the metal particles 31 in the insulating layer L2. In the insulating layers L1, L2, L3, the average particle diameter of the metal particles 31 becomes smaller stepwise for each layer toward the coil 20.

An average particle diameter of the metal particles 31 in the insulating layer L5 is smaller than an average particle diameter of the metal particles 31 in the insulating layer L6. An average particle diameter of the metal particles 31 in the insulating layer L4 is smaller than the average particle diameter of the metal particles 31 in the insulating layer L5. In the insulating layers L4, L5, L6, the average particle diameter of the metal particles 31 becomes smaller stepwise for each layer toward the coil 10.

The average particle diameters of the metal particles 31 in the insulating layers L1, L6 are equivalent to each other. The average particle diameters of the metal particles 31 in the insulating layers L2, L5 are equivalent to each other. The average particle diameters of the metal particles 31 in the insulating layers L3, L4 are equivalent to each other.

The “average particle diameter” of each of the insulating layers L1 to L6 is calculated, for example, from at least one cross section of each of the insulating layers L1 to L6. In one example, “average particle diameter” means a particle diameter at an integrated value of 50% in a particle size distribution obtained by image processing an image of at least one cross section of each of the insulating layers L1 to L6. “Average particle diameter” may mean a particle diameter at an integrated value of 50% in a particle size distribution obtained by a laser diffraction/scattering method.

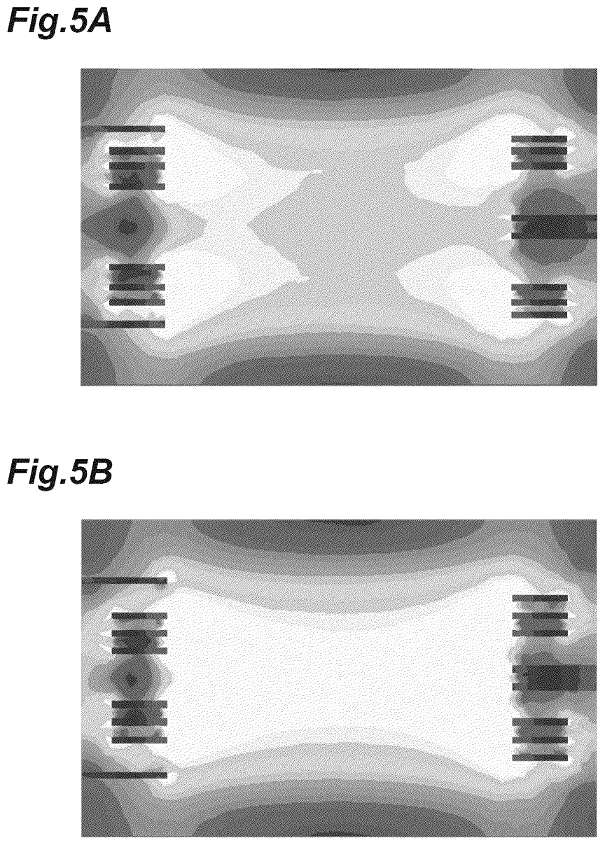

FIG. 5A and FIG. 5B are diagrams showing simulation results of the magnetic flux density distribution. In a multilayer coil component including two coils like the multilayer coil component 1, the magnetic flux density distribution was simulated for a structure (graded structure) in which the thickness of the insulating layer between the coil conductors was changed so as to increase stepwise by 50% toward the center of the two coils, and for a structure (uniform structure) in which the thickness was made uniform. FIG. 5A shows the simulation result of the graded structure, and FIG. 5B shows the simulation result of the uniform structure. The density and average particle diameter of the metal particles were set to be uniform throughout the element body in both the graded structure and the uniform structure.

In FIG. 5A and FIG. 5B, portions with higher magnetic flux density are shown in lighter colors. As shown in FIG. 5B, in the uniform structure, the magnetic flux density inside the coil is very high. On the other hand, as shown in FIG. 5A, in the graded structure, the increase in magnetic flux density inside the coil is suppressed. Thus, in the graded structure, since the distribution of magnetic flux density is uniform, magnetic saturation is less likely to occur, and decrease in inductance (L value) becomes gradual even if DC current increases. Therefore, DC superposition characteristics are improved, and inductance can be stably maintained even if DC current increases.

As described above, the multilayer coil component 1 has a graded structure, and the thicknesses t1, t2, t3 of the insulating layers L1, L2, L3 interposed between the coil conductors 11 to 14 of the coil 10 increase stepwise toward the coil 20. Thereby, the distribution of magnetic flux of the coil 10 becomes uniform, and the DC superposition characteristics of the coil 10 can be improved. Also, the thicknesses t4, t5, t6 of the insulating layers L4, L5, L6 interposed between the coil conductors 21 to 24 of the coil 20 increase stepwise toward the coil 10. Thereby, the distribution of magnetic flux of the coil 20 becomes uniform, and the DC superposition characteristics of the coil 20 can also be improved. Therefore, the DC superposition characteristics of the multilayer coil component 1 can be improved.

In the insulating layers L1, L2, L3 of the coil 10, the density of the metal particles 31 becomes lower stepwise for each layer toward the coil 20. Thereby, the distribution of magnetic flux of the coil 10 becomes more uniform, and the DC superposition characteristics of the coil 10 can be further improved. In the insulating layers L4, L5, L6 of the coil 20, the density of the metal particles 31 becomes lower stepwise for each layer toward the coil 10. Thereby, the distribution of magnetic flux of the coil 20 becomes more uniform, and the DC superposition characteristics of the coil 20 can be further improved.

In the insulating layers L1, L2, L3 of the coil 10, the average particle diameter of the metal particles 31 becomes smaller stepwise for each layer toward the coil 20. Thereby, the distribution of magnetic flux of the coil 10 becomes more uniform, and the DC superposition characteristics of the coil 10 can be further improved. In the insulating layers L4, L5, L6 of the coil 20, the average particle diameter of the metal particles 31 becomes smaller stepwise for each layer toward the coil 10. Thereby, the distribution of magnetic flux of the coil 20 becomes more uniform, and the DC superposition characteristics of the coil 20 can be further improved.

The insulating layers L1 to L6 are also provided outside and inside the coils 10, 20 when viewed from the axial direction (second direction D2). Since the insulating layers L1 to L6 may be provided on the entire surface of the element body 2, manufacturing is easy.

### Second Embodiment

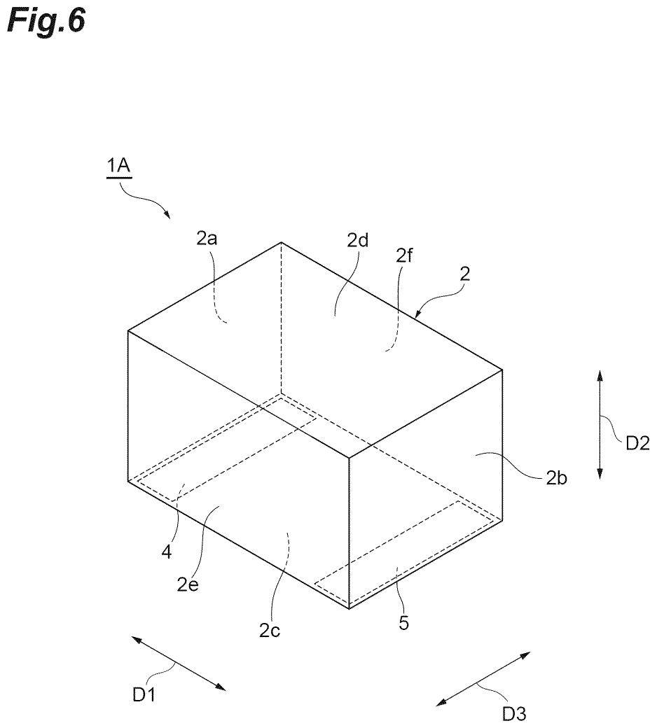

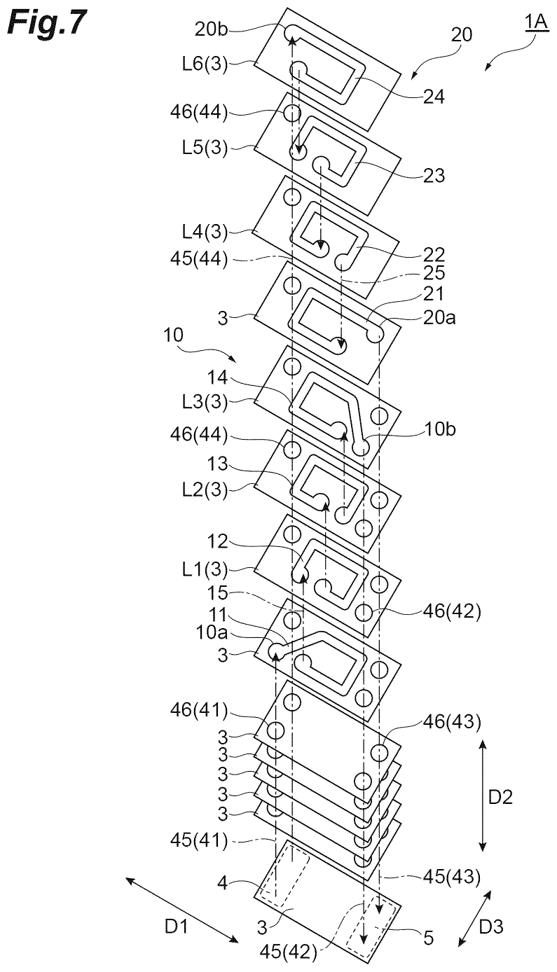

A multilayer coil component 1A according to a second embodiment will be described with reference to FIGS. 6 and 7. In FIG. 7, illustration of a cover layer (insulating layer 3) covering the coil 20 is omitted. As shown in FIGS. 6 and 7, the multilayer coil component 1A differs from the multilayer coil component 1 in that the external electrodes 4, 5 are provided only on the main surface 2c (mounting surface). The external electrodes 4, 5 have a rectangular shape with the third direction D3 as a longitudinal direction when viewed from the second direction D2. The external electrodes 4, 5 extend in the third direction D3 so as to connect the side surface 2e and the side surface 2f. The external electrodes 4, 5 are separated from each other in the first direction D1. The external electrode 4 is provided at one end portion of the main surface 2c in the first direction D1 so as to be adjacent to the end surface 2a. The external electrode 5 is provided at the other end portion of the main surface 2c in the first direction D1 so as to be adjacent to the end surface 2b. The external electrodes 4, 5 have the same shape as each other.

The multilayer coil component 1A differs from the multilayer coil component 1 also in that it includes connecting portions 41, 42, 43, 44 (hereinafter, connecting portions 41 to 44) instead of the connecting conductors 6 to 9. The connecting portion 41 connects the first end 10a of the coil 10 and the external electrode 4. The connecting portion 42 connects the second end 10b of the coil 10 and the external electrode 5. The connecting portion 43 connects the first end 20a of the coil 20 and the external electrode 5. The connecting portion 44 connects the second end 20b of the coil 20 and the external electrode 4.

Each of the connecting portions 41 to 44 is configured to include a plurality of through hole conductors 45 and a plurality of electrode pads 46. The through hole conductors 45 are provided penetrating the insulating layers 3 in the second direction D2. The electrode pads 46 are provided on the insulating layers 3. Each of the connecting portions 41 to 44 is formed by alternately laminating the through hole conductors 45 and the electrode pads 46 in the second direction D2. Each of the connecting portions 41 to 44 extends in the second direction D2 and is exposed at the main surface 2c. In FIG. 7, an example of a direction in which current flows in the through hole conductors 15, 25, 45 is indicated by arrows.

The multilayer coil component 1A also differs from the multilayer coil component 1 in that only one insulating layer 3 is disposed between the coils 10, 20, but a plurality of insulating layers 3 may be disposed between the coils 10, 20 similarly to the multilayer coil component 1.

The multilayer coil component 1A also differs from the multilayer coil component 1 in terms of the shapes of the coils 10, 20, but the configuration in which the coil 10 includes the coil conductors 11 to 14 connected by the through hole conductors 15 and the configuration in which the coil 20 includes the coil conductors 21 to 24 connected by the through hole conductors 25 are the same as those of the multilayer coil component 1.

Also in the multilayer coil component 1A, the plurality of insulating layers 3 include the insulating layers L1 to L6. The relationship among the thicknesses of the insulating layers L1 to L6, the density of the metal particles 31, and the average particle diameter of the metal particles 31 is the same as that of the multilayer coil component 1. Therefore, also in the multilayer coil component 1A, the DC superposition characteristics can be improved.

### Third Embodiment

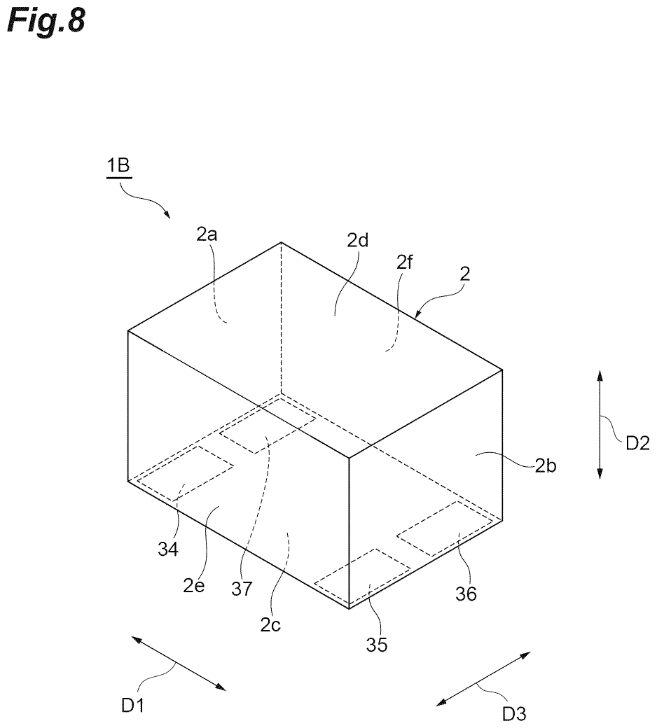

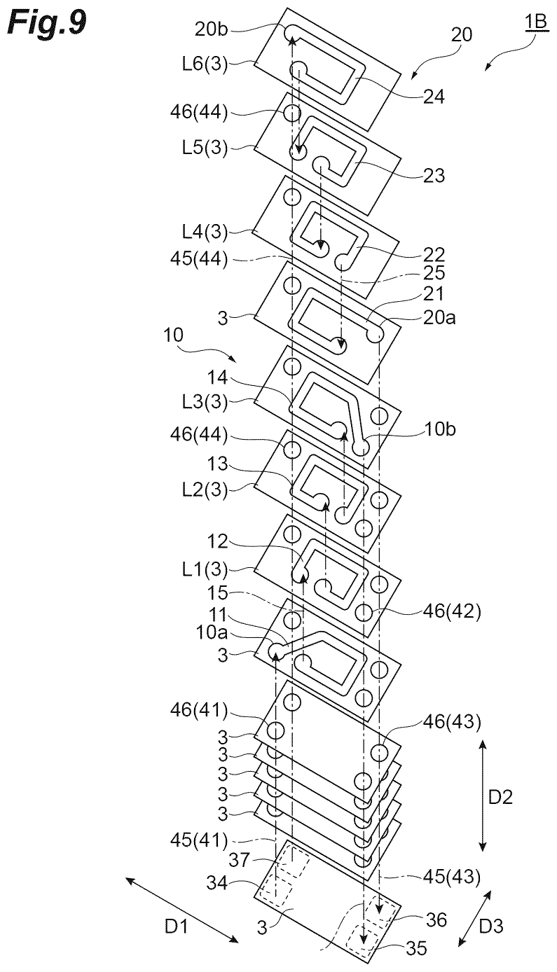

A multilayer coil component 1B according to a third embodiment will be described with reference to FIGS. 8 and 9. In FIG. 9, illustration of a cover layer (insulating layer 3) covering the coil 20 is omitted. As shown in FIGS. 8 and 9, the multilayer coil component 1B differs from the multilayer coil component 1A in that it includes external electrodes 34, 35, 36, 37 (hereinafter, external electrodes 34 to 37) instead of the external electrodes 4, 5, and is the same as the multilayer coil component 1A in other points. The external electrodes 34 to 37 are all provided on the main surface 2c (mounting surface). The external electrodes 34 to 37 are provided at four corners of the main surface 2c separated from each other.

The external electrode 34 is disposed at a corner portion formed by the end surface 2a and the side surface 2e on the main surface 2c, and is connected to the first end 10a of the coil 10 by the connecting portion 41. The external electrode 35 is disposed at a corner portion formed by the end surface 2b and the side surface 2e on the main surface 2c, and is connected to the second end 10b of the coil 10 by the connecting portion 42. The external electrode 36 is disposed at a corner portion formed by the end surface 2b and the side surface 2f on the main surface 2c, and is connected to the first end 20a of the coil 20 by the connecting portion 43. The external electrode 37 is disposed at a corner portion formed by the end surface 2a and the side surface 2f on the main surface 2c, and is connected to the second end 20b of the coil 20 by the connecting portion 44.

Also in the multilayer coil component 1B, the plurality of insulating layers 3 include the insulating layers L1 to L6. The relationship among the thicknesses of the insulating layers L1 to L6, the density of the metal particles 31, and the average particle diameter of the metal particles 31 is the same as that of the multilayer coil component 1. Therefore, also in the multilayer coil component 1B, the DC superposition characteristics can be improved.

Although the embodiments have been described above, the present invention is not necessarily limited to the above-described embodiments, and various modifications are possible without departing from the gist thereof.

In the multilayer coil components 1, 1A, 1B, both of the coils 10, 20 have the graded structure, but at least one of them may have the graded structure. In the multilayer coil components 1, 1A, 1B, each of the insulating layers L1 to L6 consists of a single insulating layer 3, but may consist of a plurality of insulating layers 3. In this case, the thickness of each of the insulating layers L1 to L6 is a total thickness of the plurality of insulating layers 3 constituting each of the insulating layers L1 to L6.

The above embodiments and the above modifications may be combined as appropriate.

What is claimed is:

1. A multilayer coil component comprising:
an element body; and
a first coil and a second coil disposed inside the element body and provided coaxially,
wherein the first coil includes a first coil conductor, a second coil conductor, and a third coil conductor,
wherein the element body includes a first insulating layer interposed between the first coil conductor and the second coil conductor, and a second insulating layer interposed between the second coil conductor and the third coil conductor,
wherein the first coil conductor, the second coil conductor, the third coil conductor, and the second coil are disposed in this order along an axial direction of the first coil, and
wherein a thickness of the second insulating layer is greater than a thickness of the first insulating layer.

2. The multilayer coil component according to claim 1,
wherein the first coil includes a plurality of coil conductors laminated along the axial direction,
wherein the element body includes a plurality of insulating layers respectively interposed between adjacent coil conductors of the plurality of coil conductors, and
wherein thicknesses of the plurality of insulating layers become greater toward the second coil.

3. The multilayer coil component according to claim 1,
wherein the first insulating layer and the second insulating layer include metal particles, and
wherein a density of the metal particles in the second insulating layer is lower than a density of the metal particles in the first insulating layer.

4. The multilayer coil component according to claim 1,
wherein the first insulating layer and the second insulating layer include metal particles, and
wherein an average particle diameter of the metal particles the second insulating layer is smaller than an average particle diameter of the metal particles in the first insulating layer.

5. The multilayer coil component according to claim 1,
wherein the second coil includes a fourth coil conductor, a fifth coil conductor, and a sixth coil conductor,
wherein the element body includes a third insulating layer interposed between the fourth coil conductor and the fifth coil conductor, and a fourth insulating layer interposed between the fifth coil conductor and the sixth coil conductor,
wherein the first coil conductor, the second coil conductor, the third coil conductor, the fourth coil conductor, the fifth coil conductor, and the sixth coil conductor are disposed in this order along the axial direction, and
wherein a thickness of the third insulating layer is greater than a thickness of the fourth insulating layer.

6. The multilayer coil component according to claim 5,
wherein the third insulating layer and the fourth insulating layer include metal particles, and
wherein a density of the metal particles in the third insulating layer is lower than a density of the metal particles in the fourth insulating layer.

7. The multilayer coil component according to claim 5,
wherein the third insulating layer and the fourth insulating layer include metal particles, and
wherein an average particle diameter of the metal particles the third insulating layer is smaller than an average particle diameter of the metal particles in the fourth insulating layer.

8. The multilayer coil component according to claim 1,
wherein the element body includes a first main surface facing the first coil in the axial direction and constituting a mounting surface, and a second main surface facing the second coil in the axial direction.

9. The multilayer coil component according to claim 1,
wherein the first insulating layer and the second insulating layer are provided outside and inside the first coil when viewed from the axial direction.

10. A multilayer coil component comprising:
an element body; and
a first coil and a second coil disposed inside the element body and provided coaxially,
wherein the first coil includes a first coil conductor, a second coil conductor, and a third coil conductor,
wherein the element body includes a first insulating layer interposed between the first coil conductor and the second coil conductor, and a second insulating layer interposed between the second coil conductor and the third coil conductor,
wherein the first coil conductor, the second coil conductor, the third coil conductor, and the second coil are disposed in this order along an axial direction of the first coil,
wherein the first insulating layer and the second insulating layer include metal particles, and
wherein a density of the metal particles in the second insulating layer is lower than a density of the metal particles in the first insulating layer.

11. A multilayer coil component comprising:
an element body; and
a first coil and a second coil disposed inside the element body and provided coaxially,
wherein the first coil includes a first coil conductor, a second coil conductor, and a third coil conductor,
wherein the element body includes a first insulating layer interposed between the first coil conductor and the second coil conductor, and a second insulating layer interposed between the second coil conductor and the third coil conductor,
wherein the first coil conductor, the second coil conductor, the third coil conductor, and the second coil are disposed in this order along an axial direction of the first coil,
wherein the first insulating layer and the second insulating layer include metal particles, and
wherein an average particle diameter of the metal particles the second insulating layer is smaller than an average particle diameter of the metal particles in the first insulating layer.

12. The multilayer coil component according to claim 10,
wherein a thickness of the second insulating layer is greater than a thickness of the first insulating layer.

13. The multilayer coil component according to claim 11,
wherein a thickness of the second insulating layer is greater than a thickness of the first insulating layer.
